(19) United States
(12) Patent Application Publication
(10) Pub. No.: US 2021/0032834 A1
(43) Pub. Date: Feb. 4, 2021

(54) BUCKET WHEEL EXCAVATOR AND METHOD OF CONTROLLING A BUCKET WHEEL EXCAVATOR

(71) Applicant: Liebherr-Components Biberach GmBH, Biberach an der Riss (DE)

(72) Inventors: Klaus GRANER, Biberach an der Riss (DE); Phillipp SUHM, Biberach an der Riss (DE); Thomas SCHULZE, Biberach an der Riss (DE); Georg HESS, Biberach an der Riss (DE)

(21) Appl. No.: 17/000,047

(22) Filed: Aug. 21, 2020

Related U.S. Application Data
(63) Continuation of application No. PCT/EP2019/053790, filed on Feb. 15, 2019.

(30) Foreign Application Priority Data
Feb. 23, 2018 (DE) 10 2018 104 153.5
Apr. 20, 2018 (DE) 10 2018 109 498.1

(51) Int. Cl. E02F 3/26; E02F 3/18; E02F 9/26; B65G 43/08

(52) U.S. Cl. CPC E02F 3/26; E02F 3/181; E02F 3/188; B65G 2201/045; E02F 9/265; B65G 43/08; E02F 3/183

(57) ABSTRACT

The present invention relates to a bucket wheel excavator whose bucket wheel is rotationally drivable and is supported at a pivotable bucket wheel boom and to a method of controlling such a bucket wheel excavator. In accordance with the invention, a mass flow and/or material flow adopted on the removal conveyor after a specific advance on the pivoting of the bucket wheel at the predetermined pivot angle speed is/are determined over the pivot angle, a desired mass flow and/or volume flow is/are specified on the removal conveyor, and then the previously specified pivot angle speed is automatically corrected using the determined mass flow and/or volume flow and the specified desired mass flow and/or volume flow to then perform the pivot cycle at the corrected pivot angle speed of the bucket wheel.

### CROSS-REFERENCE TO RELATED APPLICATIONS

This application is a continuation of International Patent Application Number PCT/EP2019/053790 filed Feb. 15, 2019, which claims priority to German Patent Application Numbers 10 2018 104 153.5 filed Feb. 23, 2018 and 10 2018 109 498.1 filed Apr. 20, 2018, the contents of which are incorporated herein by reference in their entireties.

### BACKGROUND

The present invention relates to a bucket wheel excavator whose bucket wheel is rotationally drivable and is supported at a pivotable bucket wheel boom and to a method of controlling such a bucket wheel excavator.

With such bucket wheel excavators such as are known from document DE 197 26 554 C2, the bucket wheel that rotates in working operation is additionally pivoted to clear a material terrace in an arcuate manner by the buckets that are successively used. For this purpose, said bucket wheel can be rotationally driven about a horizontal bucket wheel axis and supported at a bucket wheel boom that is itself pivotable about an upright axis of rotation. Said bucket wheel boom is here as a rule fixed to a superstructure that is travelable by an undercarriage having a crawler chassis, for example, and that can be pivoted with respect to said undercarriage. The removed material taken up by the bucket wheel or its buckets is here transferred to a removal conveyor that can have a boom conveyor belt arranged on the pivotable boom to convey the material away from the bucket wheel in the direction of the superstructure. The material can there, for example, be transferred via a chute to a further removal conveyor, for example in the form of a loading conveyor belt.

It is not all that simple here to achieve an at least reasonably constant mass flow or volume flow on the removal conveyor. The bucket wheel describes a circular path on the pivoting of the boom. Since, however, an advance takes place subsequent to a pivoting cycle, for example by traveling the bucket wheel excavator via the crawler chassis in the direction of the longitudinal excavator axis, a sickle cut results on the subsequent repeal pivoting of the bucket wheel at which the cutting depth has a maximum in the direction of the excavator axis and reduces more and more toward the side slope, i.e. on the outward pivoting of the bucket wheel in the direction of the side slope, the buckets take up less and less material, as FIG. 2 illustrates, for example. If the bucket wheel is pivoted at a constant angle speed of the boom in this process, the material flow reduces more and more and collapses more or less completely on the reaching of the side slope.

To homogenize the material flow, it has already been considered to not control the pivot angle speed uniformly, but rather to vary it via the pivot angle. A so-called cos φ control has in particular been considered that increase the pivot angle speed by a factor of 1/cos φ, i.e. increases it more and more toward the side slope. Under the assumption of a constant material height over the pivot, it can be assumed as a good approximation that the cutting depth, i.e. the sickle area and thus—with a constant material height—the cleared amount decreases in a cosine manner toward the side slope so that an almost constant material flow can be obtained by an increase of the pivot angle speed by 1/cos φ.

In practice, however, significant deviations from such a cosine model result that as a result lead to a mass flow or volume flow on the removal conveyor that is by no means uniform if such a cos φ control is implemented. On the one hand, the uppermost terrace can have variations with respect to the material height as a consequence of which the material flow also varies accordingly over the pivot.

In addition, a dead time occurs due to the system that is accompanied by a time offset between the release of the material by the bucket wheel and the occurrence of the corresponding material flow on the removal conveyor. Said dead time is here the time from the release of the material of a bucket up to the impact of the material at a point of the removal conveyor at which the material can be detected by sensors, which makes an actual regulation difficult while taking account of the actual material flow. Dead times in a double digit range of seconds are possible due to the dimension of the bucket wheel excavator and to the, as a rule, slow rotation speed of the bucket wheel, whereby classical regulation methods fail.

Furthermore, more detailed regulation models can also hardly be prepared in practice since disruption factors on parameters detectable by sensors (torques and speeds of the drives) and/or the closed loop controlled system can only be detected insufficiently and can accordingly not be compensated. Such disruption variables are, for example, wind pressing against the bucket wheel and the boom or an inclination at the pivot mechanism. It must further be noted that the material mass only has a relatively small influence relative to the cutting force at the bucket wheel.

To this extent, it is in practice up to the present day frequently the responsibility of the machine operator to ensure a more or less uniform material flow on the removal conveyor by a sensitive manual control. As a rule, the operator can set and vary the speed of the pivot mechanism independently to keep the belt filling constant, which can per se be easily estimated during the cut on an attentive observation of the bucket filling, but requires a very experienced machine operator. Such a manual correction can also take place in conjunction with the aforesaid cos φ control, with then here the cos φ control so-to-say forming a basic control and specifying the pivot angle speed via the pivot angle that can, however, be corrected by the machine operator in a manner differing from this.

It has furthermore already been considered to provide a power regulation in which the capacity of the bucket wheel drive is kept constant. The bucket wheel excavator per se hereby works permanently at its performance limit, which can, however, lead to a very high material flow and can accordingly have the consequence of an overload of the removal conveyor depending on the rock strength. Even if the removal conveyor per se can still cope with the material flow, downstream problems can result if the subsequent plants cannot process such a material flow in the background or if a maximum material flow is not required at all.

It is therefore the underlying object of the present invention to provide an improved bucket wheel excavator and an improved method for its control to avoid disadvantages of the prior art and to further develop the latter in an advantageous manner. An improved control should in particular be provided that permits a simple setting of the wanted desired mass flow or volume flow between zero and maximum and maintains this as constant as possibly over the pivot even with a variable material height without requiring a complex sensor system and a complicated regulation model for this purpose and without risking an overfill of the removal conveyor with greatly varying material parameters in so doing.

### SUMMARY

In accordance with the invention, said object is achieved by a method in accordance with claim 1 and by a bucket wheel excavator in accordance with claim 5. Preferred embodiments of the invention are the subject of the dependent claims.

It is therefore proposed to control the pivot angel speed while taking account of a material flow adopted in a previous pivot cycle with a known pivot speed and advance distance to achieve a desired material flow. The previous pivot cycle is recorded for this purpose and the material flow occurring over the pivot angle with a known pivot speed and a known advance and the known advance are used to calibrate the pivot angle speed for the further pivot cycle to achieve the desired material flow. In accordance with the invention, a mass flow and/or volume flow adopted on the removal conveyor after a specific advance on the pivoting of the bucket wheel at the predetermined pivot angle speed is/are determined via the pivot angle at a specified pivot angle speed, a desired mass flow and/or volume flow is/are specified on the removal conveyor, and then the previously specified pivot angle speed is automatically corrected with reference to the determined mass flow and/or volume flow of the determined advance distance and the specified desired mass flow and/or volume flow to then perform the pivot cycle at the corrected pivot angle speed of the bucket wheel.

The initially specified pivot angle speed can generally be specified in different manners. For example, a pivot cycle can be run at a constant pivot angle speed and the adopted material flow (that will then collapse more and more toward the side slope in this case) can be recorded in this process. To correct the pivot angle speed for a later pivot cycle so that a desired, in particular constant material flow is achieved, the constant, previously specified pivot angle speed can be corrected by the ratio of the desired material flow to the actual material flow and the ratio of the advance distances. Under the above assumption that the material flow decreases more and more as the pivot angle increases with a constant pivot angle speed, this results in an ever greater increase in the pivot angle speed as the pivot angle increases.

Alternatively or additionally to the previously described procedure, a continuous regulation can also be superposed on the specification of the pivot angle speed. In such a regulation, the measured mass flow and the specified mass flow can be compared with one another during each pivot and the pivot angle speed can already be adapted during every pivot.

The initially specified pivot angle speed can, however, already be an angle-dependent function, for example have a cosine dependent progression, for example in the sense of 1/cos φ. Under ideal conditions, this would per se already effect a constant material flow in a sickle cut. If, however, fluctuations result in the material flow, for example due to varying material properties or material heights, the previously specified, cosine dependent pivot angle speed progression will be calibrated in a corresponding manner in that the desired material flow is put into a relationship with the actually measured material flow while taking account of the advance distance. The cosine progression is hereby corrected.

The correction of the pivot angle speed can in particular be carried out using the following relationship:

$${ω}_{des} = {ω}_{act} \cdot \frac{{m}_{des}}{{m}_{act}} \frac{{s}_{n - 1}}{{s}_{n}} ,$$

where ω_{des} is the desired pivot angle speed, ω_{act} is the previously specified pivot angle speed, m_{des} is the desired material flow, m_{act} is the measured actual material flow, sₙ is the advance before the pivot, and sₙ₋₁ is the advance before the previous pivot, with a pivot angle dependent desired progression being obtained for said pivot angle speed due to the pivot angle related recording of the material flow.

If the previously specified pivot angle speed ω_{act}(φ) is already specified as a progression or function in dependence on the pivot angle φ, an analog procedure can be followed:

$${ω}_{des} ( ϕ ) = {ω}_{act} ( ϕ ) \cdot \frac{{m}_{des} ( ϕ )}{{m}_{act} ( ϕ )} \frac{{s}_{n - 1}}{{s}_{n}} .$$

A mass flow can here be specified as the material flow and can be measured accordingly, in particular by a weight sensor that can be arranged at the removal conveyor to weigh the material unloaded there.

Alternatively or additionally, however, the volume flow placed or arising on the removal conveyor can also be measured in that the material unloaded there is detected volume-wise. Different sensors can be used for this purpose by means of which the surface or surface contour of the material flow on the unloading conveyor can be determined. They can, for example, be radar sensors, ultrasound sensors, laser stripe sensors, and/or laser sensors by means of which the surface contour can be scanned and determined and the cross-sectional surface of the material flow can be determined therefrom.

If both the mass flow and the volume flow are detected by sensors, this also permits a determination of the density of the material cleared away, which can be advantageous for the further processing of the material.

In order not to falsify the relationship between the pivot angle and the produced material flow by the dead time of the bucket wheel excavator, the recorded relationship between the measured material flow and the measured pivot angle is corrected by said dead time in an advantageous further development of the invention.

To in particular determine the mass flow and/or volume flow adopted on the removal conveyor using the pivot angle, the mass flow and/or volume flow actually present on the removal conveyor can be detected relative to the pivot angle of the bucket wheel excavator, a dead time between a release of the material at a bucket until the measurement of this released material on the removal conveyor can be determined, and finally the association between the measured mass flow and/or volume flow to the pivot angle can be corrected by the determined dead time while taking account of the pivot angle speed. Such a dead time correction takes account of the circumstance that material released at a bucket cannot directly pass the sensor device for detecting the mass flow and/or volume flow, but rather requires a certain time period to there that can amount to multiple seconds.

The dead time can here be determined in generally different manners, in particular in that operating variables of the bucket wheel excavator are monitored for characteristics that accompany the decisive points in time for the determination of the dead time, i.e. the release of the material of a bucket and the measured point in time at the measurement of the mass flow or volume flow. A time offset between a load change and/or a change of the rotation speed of the bucket wheel, on the one hand and a signal change of the mass flow and/or volume flow sensor device, on the other hand, can in particular be determined to determine the dead time. This starts from the consideration that on the release of the material by a bucket, the load pick-up of the bucket wheel drive—that is, for example, the current consumption or the hydraulic power consumption—increases due to the resistance occurring in this process and/or the rotation speed of the bucket wheel drops at least briefly so that the point in time of the release of the material can be determined in that a corresponding increase of the energy requirement or of the speed drop is determined. On the other hand, the signal of the mass flow and/or volume flow sensor device will change significantly if the material flow starts on the removal conveyor. Alternatively or additionally, the dead time can also be determined using the knowledge of the geometry (bucket wheel, lead angle, distance up to the belt scale) and using kinematics (speed of the bucket wheel, belt speed).

Said scaling of the desired pivot angle speed by the relationship of the material flow and of the advance distance, that was measured in a previous pivot cycle at a known pivot angle speed, to a wanted desired material flow can generally be performed a different number of times. It may be sufficient here if, for example, only the first pivot cycle is recorded at a known pivot angle speed and advance distance with respect to the adopted material flow, i.e. the mass flow and/or volume flow. It is here advantageously not the first cut into a terrace that is used. In the first cut in a terrace, the determined advance distance is not representative due to a rearward movement and subsequent forward movement. The advance distance can only be used sensibly from a completed cut with material removal onward. In an advantageous further development of the invention, the scaling can, however, also be continuously tracked to take account of changing material properties in the terrace machining or resulting inclination changes. A new scaling or new calibration can, for example, take place after every fifth or every third pivot cycle or also on every pivot cycle.

The control or the bucket wheel excavator can advantageously manage with a sensor system typical per se with bucket wheel excavators, with it being able to be sufficient, for example, to provide a belt scale at the removal conveyor to measure the material weight effective there and to thus be able to determine the mass flow, in particular when the belt speed is detected and/or constantly specified in this process, with a belt speed sensor and/or a conveyor motor speed sensor being able to be provided to determine the conveying speed of the removal conveyor, further to associate an angle sensor with the pivot mechanism for pivoting the bucket wheel boom to be able to measure the angle whose derivation can simultaneously also be used as the angle speed, with alternatively, an angle sensor and an angle speed sensor also being able to be provided separately. Furthermore, the load and speed of the bucket wheel or of the bucket wheel motor can be measured by a suitable sensor system, for example a current meter or a pressure sensor and a speed sensor to be able to determine the drive torque and the speed of the bucket wheel. If alternatively or additionally to the mass flow, the volume flow is detected in said manner, a corresponding surface sensor as previously explained can be provided.

To avoid an overload of the bucket wheel excavator and of its drive, a power regulation is superposed on the aforesaid pivot angle speed control in an advantageous further development of the invention. If there is a risk of the bucket wheel excavator or of one of its drives entering into the overload range or if a certain power limit is reached, said power regulation of the pivot speed can be reduced, i.e. the bucket wheel excavator is not pivoted at the desired pivot angle speed determined per se, but only at a correspondingly decreased reduced desired speed. A superposition of the control with the power regulation results in a limitation of the material flow in the power limit range.

### BRIEF DESCRIPTION OF THE DRAWINGS

The invention will be explained in more detail in the following with reference to a preferred embodiment and to associated drawings. There are shown in the drawings:

FIG. 1: a schematic representation of a bucket wheel excavator; and

FIG. 2: a schematic representation of the sickle cut resulting with the bucket wheel excavator of FIG. 1.

### DETAILED DESCRIPTION

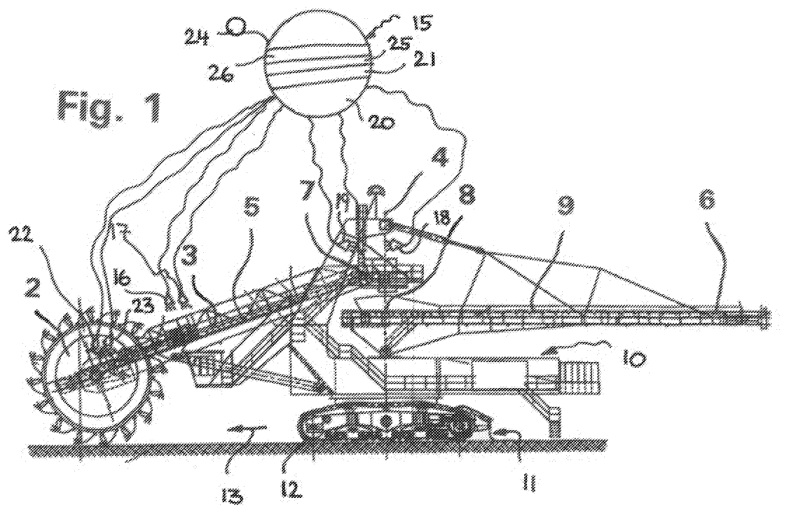

As FIG. 1 shows, the bucket wheel excavator 1 can have in a known manner a bucket wheel 2 that is rotationally drivable about a horizontal bucket wheel axis and can have buckets at the peripheral side to be able to release and pick up material of an area or of a terrace to be machined, in particular earth and/or rocks.

Said bucket wheel 2 can be supported at a bucket wheel boom 3 in the form of a boom that can be pivotably connected in an articulated manner to a superstructure 10 and that can be pivoted by a pivot mechanism having a pivot drive. Said bucket wheel excavator 3 can more precisely be pivoted together with the superstructure 10 about said upright pivot axis 4 with respect to the undercarriage 11 that can in particular have a crawler chassis 12.

To be able to convey away the material picked up by the bucket wheel 2, a removal conveyor 5, for example in the form of a continuously revolving conveyor belt, can be associated with said boom or bucket wheel boom 3. Said removal conveyor 5 conveys the material taken over by the bucket wheel 2 along the boom to the superstructure 10, where the material conveyed away can be transferred via a chute 8 to a further removal conveyor 9 that can, for example, likewise comprise a continuously revolving conveyor belt and that can be configured as a loading conveyor.

As FIG. 1 further shows, the bucket wheel boom 3 can be connected in an articulated manner to the superstructure 10 luffable about a horizontal transverse axis 7.

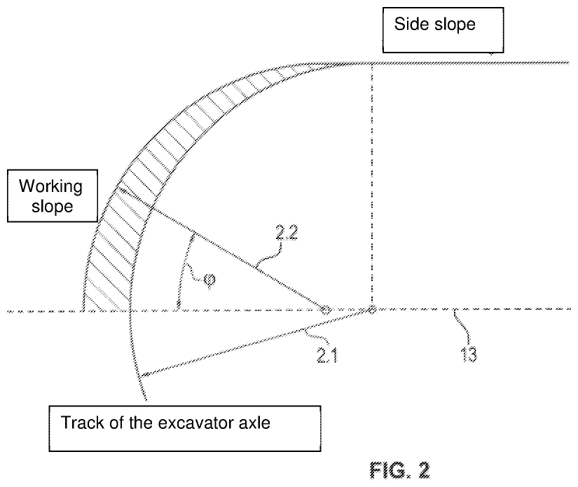

FIG. 2 illustrates the cut relationships at the bucket wheel 2 that are adopted in working operation, with the arc 2.1 illustrating the arcuate pivot path of the bucket wheel 2 in a first pivot cycle n−1 and with the arc 2.2 illustrating the again arcuate path of the bucket wheel in a further pivot value cycle n after the bucket wheel excavator 1 has experienced an advance by traveling the crawler chassis 12 in the longitudinal direction of the bucket wheel excavator 1. The sickle cut illustrated in FIG. 2 that has a maximum cutting depth in the direction of the longitudinal excavator axis or of the food that becomes smaller and smaller toward the side slope results from said advance, on the one hand, and the arcuate path of the bucket wheel 2, on the other hand.

In this respect, the pivot angle of the boom or of the bucket wheel boom 3 can be designated by the angle φ that typically amounts to φ=0 when the bucket wheel boom 3 so-to-say stands neutral at the center along the longitudinal excavator axis or along the advance 13 and that, on the other hand, amounts to (φ)=90° when the bucket wheel 2 has reached the side slope. In a pivot cycle, the bucket wheel 2 can thus therefore generally be pivoted in a range from −90°≤φ≤+90°, with, however, optionally even smaller pivot angle ranges of, for example, +/−80° or +/−70° being able to be provided, but with asymmetrical designs in accordance with FIG. 2 also equally being possible.

A control apparatus 15 of the bucket wheel excavator 1 that has an electronic data processing unit, for example comprises a microprocessor and software stored in a memory can in particular control the bucket wheel excavator 1 as follows:

The bucket wheel excavator 1 can first be pivoted in a calibration run n−1 at a specified pivot angle speed ω_{act}, in that the pivot mechanism is controlled accordingly and the bucket wheel boom 3 is correspondingly pivoted about the axis 4. In this process, the bucket wheel 2 runs in a rotationally driven manner in a manner known per se to release material and to unload it on the removal conveyor 5. The specified pivot angle speed ω_{act} can, for example, be constantly specified or can have a predetermined cosine progression.

In this pivot cycle n−1, the material flow adopted on the removal conveyor 5 is measured by sensor, and indeed in particular in the form of a mass flow and/or in the form of a volume flow. For this purpose, a mass flow sensor device 16 and/or a volume flow sensor device 17 that determine the mass conveyed through on the removal conveyor 5 in the corresponding removal conveyor section or the volume conveyed through can be associated with the removal conveyor 5 so that the signal of the mass flow sensor device 16 indicates the mass flow m and the signal of the volume flow sensor device 17 indicates the volume flow v.

In said pivot cycle n−1, the pivot angle φ and the pivot angle speed ω of the bucket wheel excavator 3 are simultaneously detected by an angle sensor 18 and an angle speed sensor 19 that can be associated with the pivot mechanism.

The operation variables mass flow m, volume flow v, pivot angle φ, and pivot angle speed ω hereby detected are supplied to the control apparatus 15, in particular to a recording device 20 implemented therein to record the adopted mass flow and/or volume flow relative to the pivot angle and to the pivot angle speed.

Furthermore, the dead time, i.e. the time period between the release of the material of an excavator bucket up to the detection of the material by said mass flow and/or volume flow sensor devices 16 and 17, is determined by a dead time determination device 21. Said dead time determination device 21 can in this respect comprise a load pick-up sensor, for example in the form of a current consumption sensor 22 for detecting the current consumption of the rotary drive to rotate the bucket wheel 2, and/or a pressure sensor with a hydraulic design of the drive, and/or a speed sensor 23 for detecting the speed of the bucket wheel. Said dead time can specifically be determined in that, for example, a characteristic increase of the energy consumption, for example the current consumption, or a pressure increase and/or a characteristic drop of the speed of the bucket wheel 2 is determined, with the point in time at which this change occurs being able to be evaluated as the point in time of the release of the material. On the other hand, the signal of the mass flow and/or volume flow sensor device 16 or 17 respectively is monitored as to when a certain increase starts. The time difference between the occurrence of both changes can be evaluated as the dead time. The dead time T can, however, also be determined using the knowledge of the geometry (bucket wheel, lead angle, distance up to the belt scale) and of kinematics (speed of the bucket wheel, belt speed).

The control apparatus 5 can then correct the mass flow m_{act} and/or volume flow v_{act} recorded in the pivot cycle n−1 via the pivot angle φ to correct said dead time. The angular offset that is caused by the dead time can advantageously be determined from the likewise recorded and/or already known pivot angle speed ω_{act} in the pivot cycle n−1, whereupon the control apparatus 15 can accordingly correct the mass flow and/or the volume flow using the pivot angle.

For a next pivot cycle n, the control apparatus 15 can then use the basis of a desired material flow in the form of a wanted desired mass flow m_{des} and/or in the form of a desired volume material flow v_{des} on the removal conveyor 5, with the control apparatus 15 being able to have input means 24, for example in the form of a slide control, a rotary knob, a joystick, or a touchscreen by means of which a machine operator or a control station can input the wanted desired mass flow or desired volume flow.

The control apparatus 15 scales or calibrates the pivot angle speed ω using the detected material flow and the wanted desired material flow and the respective advance path. A scaling or calibration device 25 that can be implemented in the control apparatus 15 can in particular determine the desired pivot angle speed ω_{des}(φ) using the following relationship:

$${ω}_{des} ( ϕ ) = {ω}_{act} ( ϕ ) \frac{{m}_{des} ( ϕ )}{{m}_{act} ( ϕ )} \frac{{s}_{n - 1}}{{s}_{n}} .$$

where ω_{des}(φ) is the desired pivot angle speed for the pivot cycle n, ω_{act}(φ) is the specified pivot angle speed in the pivot cycle n−1, m_{des}(φ) is the desired mass flow specified by the input means 24 for the pivot cycle n, m_{act} is the mass flow measured by sensor in the pivot cycle n−1, sₙ₋₁ is the previous advance distance before the pivot cycle n−1, and sₙ is the advance distance before the pivot cycle n.

If a volume flow control is provided or if a desired volume flow should be achieved, said scaling or calibration module 25 can proceed using the following relationship:

$${ω}_{des} ( ϕ ) = {ω}_{act} ( ϕ ) \cdot \frac{{v}_{des} ( ϕ )}{{v}_{act} ( ϕ )} \frac{{s}_{n - 1}}{{s}_{n}} ,$$

where ω_{des}(φ) is the desired pivot angle speed for the pivot cycle n, ω_{act}(φ) is the pivot angle speed in the preceding pivot cycle n−1, v_{des} is the set desired volume flow, v_{act}(φ) is the volume flow measured in the previous cycle n−1, sₙ₋₁ is the previous advance distance before the pivot cycle n−1, and sₙ is the advance distance before the pivot cycle n.

The desired mass flow m_{des} and the desired volume flow v_{des} are advantageously desired as constant and are therefore not specified as a function of the pivot angle φ, although this would nevertheless be possible.

The control apparatus 15 advantageously further comprises a power limiter 26 that is superposed on the control of the pivot angle speed and limits or reduces the desired pivot angle speed determined as previously explained when the drives of the bucket wheel excavator 1 are at risk of entering the overload range and/or too great a material amount is at risk of being unloaded on the removal conveyor 5. Said power limiter 26 can monitor the power consumption of the drives via corresponding sensor devices and/or monitor the signals of the mass flow and/or volume flow sensors 16 and 17 as input variables and can limit or reduce the pivot angle speed on the basis of these input variables.

We claim:

1. A method of controlling a bucket wheel excavator whose bucket wheel rotating at a constant speed is pivoted at an angle speed over a pivot angle by a bucket wheel boom pivot drive and in so doing places removed material on a removal conveyor, the method comprising:
a first advance moving of the bucket wheel excavator by its undercarriage toward the rock mass to be removed with a detection of the implemented advance distance, wherein the first moving occurs after completion of a pivot by the bucket wheel over the pivot angle during a removal of material;
pivoting the bucket wheel boom in a pivot cycle with a determination of the pivot angle speed over the pivot angle and of the mass flow and/or volume flow on the removal conveyor over the pivot angle;
a second advance moving of the bucket wheel excavator by its undercarriage toward the rock mass to be removed with a detection of the implemented advance distance, wherein the second moving occurs after completion of the pivot cycle;
specifying a constant wanted desire mass flow and/or volume flow on the removal conveyor;
automatically correcting the pivot angle speed determined in a last pivot cycle in dependence on the pivot angle using the mass flow and/or volume flow previously determined using the pivot angle, wherein the desired mass and/or volume flow of an immediately previous implemented advance distance and an advance distance implemented before the last pivot so that the adopted mass flow and/or volume flow are close to the wanted desired mass flow and/or volume flow; and
pivoting the bucket wheel boom in a further pivot cycle at the corrected pivot angle speed in dependence on the pivot angle.

2. The method of claim 1, further comprising the following upon the determination of the mass flow and/or volume flow adopted on the removal conveyor over the pivot angle:
detecting the mass flow and/or volume flow at the removal conveyor, wherein the detecting is by a mass flow and/or volume flow sensor relative to the pivot angle of the bucket wheel;
determining a dead time between a release of the material of a bucket up to the detection of this material at the removal conveyor; and
correcting by the determined dead time the association of the measured mass flow and/or volume flow with the pivot angle, wherein the correcting occurs while taking account of the determined pivot angle speed over the pivot angle.

3. The method of claim 2, wherein determination of the dead time, a transport path of the bucket wheel excavator from the release of the material of a bucket up to a mass flow and/or volume flow sensor, and of a bucket wheel speed and a removal conveyor speed, a time offset between a load change of the bucket wheel and/or a change of the rotational speed of the bucket wheel, and a signal change of the mass flow and/or volume flow sensor, is determined with said load change and/or rotational speed of the bucket wheel being measured by a load pick-up sensor system and/or by a rotational speed of the bucket wheel sensor system.

4. The method of claim 3, further comprising determining the dead while taking account of the transport path of the bucket wheel excavator from the release of the material of a bucket up to a mass flow and/or volume flow sensor, and of a rotational speed of a bucket and a removal conveyor speed.

5. The method of claim 4, further comprising monitoring a load of the removal conveyor and/or a strain of at least the bucket wheel drive and/or of the removal conveyor drive, wherein the monitoring is performed by a power limiter) and the method further comprises limiting and/or reducing the corrected pivot angle speed when the load of the removal conveyor and/or the strain on the at least one drive reaches and/or exceeds a strain limit.

6. A bucket wheel excavator comprising:
a bucket wheel supported in a rotationally drivable manner at a bucket wheel boom that is pivotable about a pivot axis by a pivot mechanism and
a control apparatus for controlling a pivot angle speed in dependence on a pivot angle, wherein the control apparatus comprises:
a determination device for determining a mass flow and/or volume flow adopted on the pivoting of the bucket wheel at a specified pivot angle speed on a removal conveyor in a preceding pivot cycle via the pivot angle;
an inputter for inputting a desired mass flow and/or volume flow on the removal conveyor;
a first determiner for determining the advance distance of the bucket wheel excavator between two pivot procedures;
a second determiner for determining the pivot angle speed in dependence on the desired mass flow and/or volume flow, with the second determiner configured to deliver a calibration device for an automatic correction of the specified pivot angle speed using the determined mass flow and/or volume flow and the desired mass and/or volume flow; and
a pivot control device for pivoting the bucket wheel.

7. The bucket wheel excavator of claim 6, wherein the inputter comprises a selection module for a variable selection of desired mass flow and/or volume flow from a range between a mass flow and/or a volume flow selectable as a minimum and a mass flow and/or a volume flow selectable as a maximum.

8. The bucket wheel excavator of claim 6, wherein the second determiner device is on the removal conveyor over the pivot angle and comprises:
a mass flow and/or volume flow sensor for detecting the mass flow and/or volume flow at the removal conveyor;
a pivot angle sensor for detecting the pivot angle of the bucket wheel boom relative to the pivot angle of the bucket wheel;
an advance sensor system for detecting the advance distance of the bucket wheel excavator between two pivots by the undercarriage; and
a recording device for recording the detected mass flow and/or volume flow at the removal conveyor and the detected pivot angle of the bucket wheel.

9. The bucket wheel excavator of claim 8, wherein the second determiner further comprises:
a dead time determination device for determining a dead time between a release of the material of a bucket up to the detection of this material at the removal conveyor; and
a corrector for correcting a recorded association of the measured mass flow and/or volume flow with the pivot angle by the determined dead time while taking account of the specified pivot angle speed.

10. The bucket wheel excavator of claim 9, wherein the dead time determination device is configured to determine a time offset between a load change of the bucket wheel and/or a change of the rotational speed of the bucket wheel, and a signal change of the mass flow and/or volume flow sensor, using the signals of a load pick-up sensor system for detecting a load pick-up of the drive of the bucket wheel and/or a bucket wheel speed sensor system for detecting the bucket wheel speed, and the signals of the mass flow and/or volume flow sensor.

11. The bucket wheel excavator of claim 9, wherein the dead time determination device is configured to determine the dead time while taking account of a transport path of the bucket wheel excavator from the release of the material of a bucket up to a mass flow and/or volume flow sensor, and of a bucket wheel speed and a removal conveyor speed.

12. The bucket wheel excavator of claim 6, further comprising a power limiter superposed on the control apparatus, wherein the power limiter is configured to monitor a load of the removal conveyor and/or a strain of at least the bucket wheel drive and/or the removal conveyor drive, and wherein the power limited is configured to limit and/or reduce the corrected pivot angle speed when the load of the removal conveyor and/or the strain on the at least one drive reaches and/or exceeds a strain limit.
